(19) United States
(12) Patent Application Publication
(10) Pub. No.: US 2007/0083404 A1
(43) Pub. Date: Apr. 12, 2007

(54) System and method for partnering an independent business enterprise with a privately owned correctional facility

(76) Inventor: Beverly Kathryn Biedenharn, West Monroe, LA (US)

Correspondence Address: PERRET DOISE;A PROFESSIONAL LAW CORPORATION, P.O. DRAWER 3408, LAFAYETTE, LA, 70502-3408, US

(21) Appl. No.: 11/213,423

(22) Filed: Aug. 26, 2005

(51) Int. Cl. G06F 17/50

(52) U.S. Cl. 705/7

(57) ABSTRACT

A system and method for partnering an independent business enterprise with a privately owned correctional facility. The independent business enterprise is located within the confines of the privately owned correctional facility. The independent business enterprise employs all or part of the general prison population as its workforce. The privately owned correctional facility operates a banking center and provides banking services to the prisoner workforce.

### FIELD OF THE INVENTION

The present invention relates to a system and method for partnering an independent business enterprise with a privately owned correctional facility, and more particularly to a system and method in which an independent business enterprise is located within the confines of a privately owned correctional facility and employs the prisoner population as its workforce.

### BACKGROUND OF THE INVENTION

The number of privately owned correctional facilities or private prisons has grown over the past few years as federal and state prison systems increasingly contract with private prisons for the incarceration of federal and state prisoners. The reason for this growth is cost savings. It is more economical for a federal or a state prison system to pay a private prison to incarcerate their prisoners because the fees charged are less than the costs incurred by the government prison to house the prisoners.

Private prisons can charge lower fees and still maintain profitability because their operating expenses are comparatively less than those of federal or state prisons. Private prisons save money both during construction and afterwards during operation. Savings are achieved in the construction phase because private prisons can build their facilities in half the time normally required for government prisons. Private prisons are also free from purchasing restrictions and subcontracting quotas that plague federal and state prison systems during construction. This may result in a savings of 15% to 25%.

Private prisons also operate leaner. They have lower labor costs, primarily attributable to facility design that requires fewer guards to monitor the inmates. Because private prisons are not bound by civil service rules, they typically use about one-third less administrative personnel as compared to government prisons. In addition, private prisons-which are not bound by purchasing restrictions can buy supplies at lower costs than government prisons. Private prisons have found other ways to reduce costs and increase profitability.

For example, Wackenhut Corrections Corporation (“WCC”), which operates a private prison in Texas, entered into an arrangement with Lockhart Technologies, Inc., a private manufacturer of computer components. Lockhart Technologies relocated its manufacturing facility within the prison and hired WCC's inmates as its workforce. Lockhart Technologies employs between 100 and 500 inmates at minimum wage. The prisoners are allowed to keep up to 20% of their income. The prisoners' remaining income goes to pay for court fees, outstanding loans, social security, taxes, restitution, child support, and incarceration expenses. WCC receives between 8% and 9% of the prisoners' gross salary.

Despite these efforts, the need still exists for a more economical model for partnering an independent business enterprise with a privately owned correctional facility.

### SUMMARY OF THE INVENTION

The present invention provides a novel prison system and method which brings together the following entities for their mutual benefit:

1. Federal and/or state prison systems;

2. Privately owned correctional facilities;

3. Independent business enterprises such as manufacturers;

4. The local communities where the correctional facilities are located; and

5. Inmates.

The prison system and method of the present invention includes the establishment of a privately owned correctional facility within a community. The correctional facility may house up to about 640 prisoners. The prisoners may be supplied by state and/or federal prison systems. The government prison systems pay the privately owned correctional facility to incarcerate their prisoners. The payment is less than the cost of housing the prisoners within a government prison.

The prison system and method of the present invention also includes associating or partnering an independent business enterprise such as a private manufacturing business with the privately owned correctional facility. The business enterprise preferably builds a facility within the confines of the correctional facility. The business employs all or part of the prisoners as their workforce and pays them a salary (e.g., no less than minimum wage). The business gets a ready supply of workers and a federal tax credit for employing the prisoners. This means that the cost of employing the prisoners is low, and may be at or below cost.

The prison system and method also involves a process whereby the private prison preferably receives a portion of each prisoner's salary (e.g., 50% of daily wages but no more than about $22.00 per day per prisoner). The prison may use these proceeds to pay operational expenses. The proceeds received from the prisoner workforce enable the privately owned correctional facility to charge lower fees for incarcerating prisoners.

For their part, the inmates obtain gainful employment, which reduces prisoner discontent. The prisoner workforce also gets to keep a portion of the salary for personal use.

The local community where the prison is located benefits. The prison preferably employs people from the local community. It is preferred that about 100 people from the local community are employed by the prison. These employees will make up all or a portion of the prison administrative staff and guards.

In one embodiment of the present invention, the privately owned correctional facility includes a banking center that provides banking services to the prisoner workforce. The private correctional facility operates the banking center. The money the prisoners are allowed to keep may be placed in an account maintained by the banking center and may be used by the prisoners for personal items sold at the facility, as for example, hygiene items and/or canteen items. The money may also be used to support the prisoners' families, or used to pay for court costs, child support, court fines, and other similar expenses.

In summary, the benefits of the novel prison system and method of the present invention are numerous and include:

1. The state or federal government pays less to house their prisoners;

2. The privately owned correctional facility derives operational revenue from prisoner employment;

3. The privately owned correctional facility employs people from the local community;

4. The business enterprise has a workforce that is available and able to work in shifts for a twenty-four hour period seven days a week;

5. The tax credits provided to the private business means that its workforce related costs are low or at or below cost;

6. The prisoners have gainful employment and make money which can be used to support their families or to purchase personal items.

These objects and advantages of the present invention and others will be readily apparent to one skilled in the art to which the invention pertains from a perusal of the claims and the following detailed description of preferred embodiments when viewed in conjunction with the appended drawing.

### BRIEF DESCRIPTION OF THE DRAWINGS

FIG. 1 is a pictorial top view of the prison system of the present invention.

FIG. 2 is a flowchart of the application of the prison system of the present invention.

### DETAILED DESCRIPTION OF THE PREFERRED EMBODIMENTS

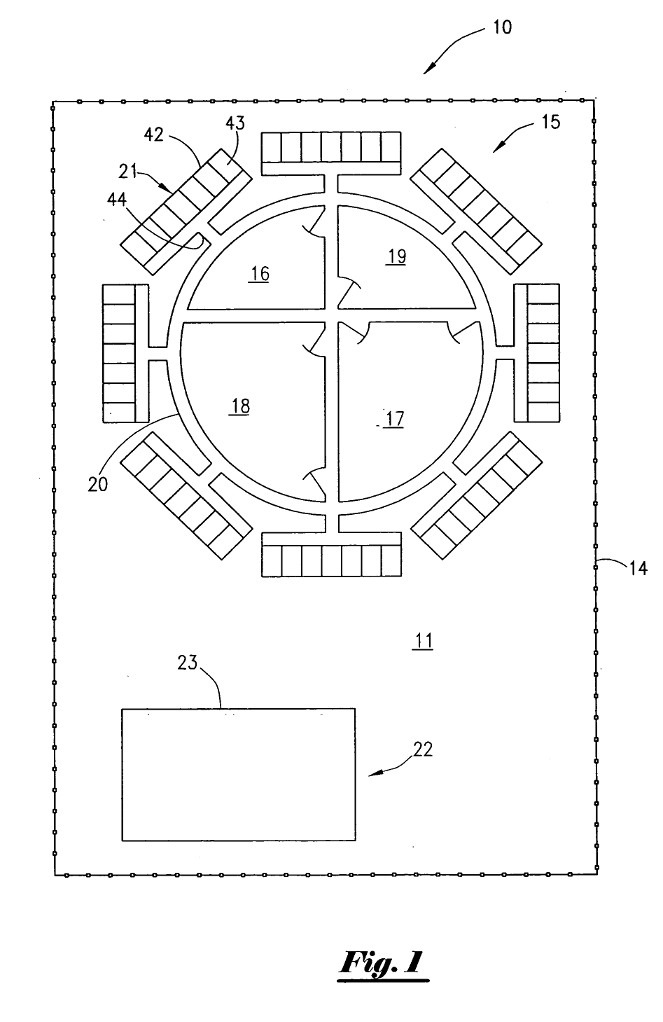

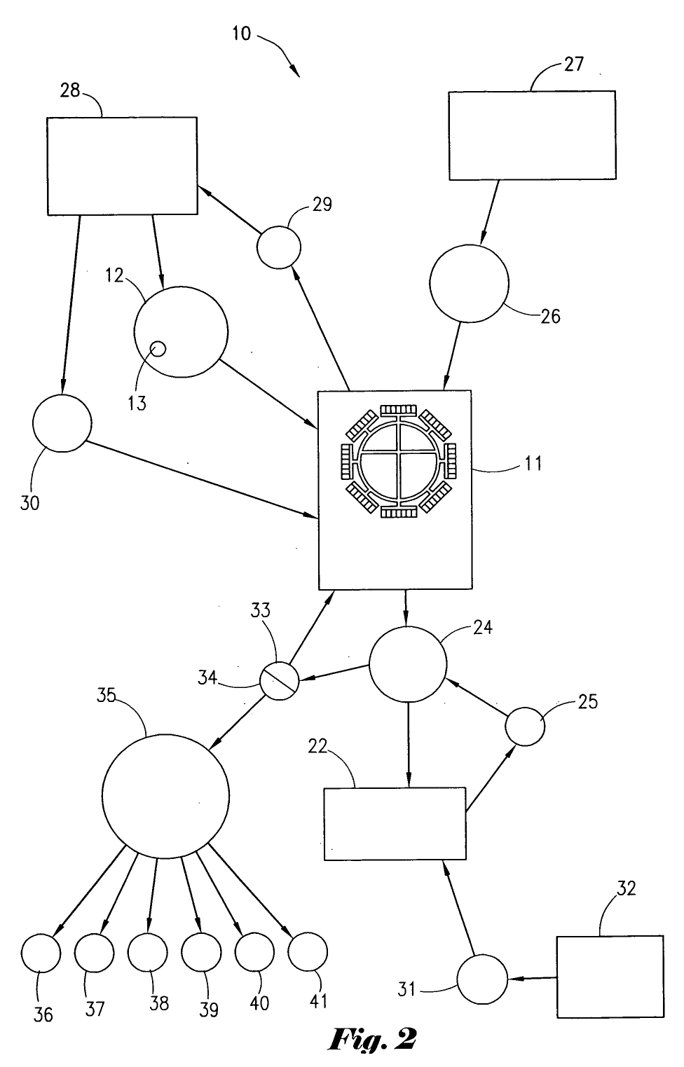

With reference to the figures where like elements have been given like numerical designation to facilitate an understanding of the present invention, in particularly with reference to the embodiment of the present invention illustrated in FIGS. 1 and 2, prison system 10 includes privately owned correctional facility 11. Privately owned correctional facility 11 preferably includes general prison population 12 composed of prisoners 13.

With reference to FIG. 2, privately owned correctional facility 11 may be supplied with all or part of general prison population 12 from government entity 28. Government entity 28 may be a state or federal government prison system, or both, (e.g., a state or federal Department of Corrections). Privately owned correctional facility 11 may charge fee 29 to government entity 28 for incarcerating general prison population 12. Government entity 28 sends proceeds 30 to privately owned correctional facility 11 as payment of fee 29. Privately owned correctional facility uses proceeds 30 to pay for operational and other expenses.

Again with reference to FIG. 1, privately owned correctional facility 11 may include outer boundary 14 for containing general prison population 12. Preferably, outer boundary 14 is a containment device such as a prison wall, prison fence, or a similar containment structure.

Privately owned correctional facility 11 may also include detention unit 15, preferably located within outer boundary 14 as shown in FIG. 1. Detention unit 15 may contain central building 20 and plurality of prisoner housing units 21. Preferably, plurality of prisoner housing units 21 extend outwardly from central building 20. It is preferred that detention unit 15 have between two and ten prisoner housing units 21, and more preferably ten prisoner housing units 21.

The design of detention unit 15 ensures that general prison population 12 may be guarded with a minimum of group of correctional facility employees 26. Detention unit 15 may include at least one administrative office 16, library 17, cafeteria 18, and banking center 19. Administrative office 16, library 17, cafeteria 18, and banking center 19 are preferably situated in central building 20.

It is preferred that central building 20 be circular shaped. It is also preferred that plurality of prisoner housing units 21 each be designed with distal end 42 containing group or individual cells or dorms 43 for confinement of prisoners 13. Preferably, each prisoner housing unit 21 has 50 to 80 cells or dorms 43, and more preferably 80 cells 43. Distal end 42 may be any suitable shape; however, it is preferred that distal end 42 have a rectangular shape as shown in FIG. 1. Each prisoner housing unit 21 may further include proximal end 44 that interconnects distal end 42 to central building 20. Preferably, proximal end 44 is designed as a longitudinal pathway (preferably enclosed) which interconnects distal end 42 to central building 20.

As illustrated FIG. 1, detention unit 15 preferably includes banking center 19. Banking center 19 may provide banking services, including processing, depositing, and withdrawing of funds. Preferably, banking center 19 uses computers and/or one or more computer systems to perform the banking services and provide banking transactions. Privately owned correctional facility 11 may operate banking center 19. Banking center 19 may provide banking services to prisoner workforce 24.

With reference to FIGS. 1 and 2, prison system 10 preferably includes independent business enterprise 22. Independent business enterprise 22 may operate business 25 from within outer boundary 14. Independent business enterprise 22 may be any type of business entity such as a sole proprietorship, partnership, limited liability company, or corporation. Independent business enterprise 22 may conduct any type of business, but preferably, the business conducted is a manufacturing business, such as one that builds a product or a component of a product.

It is preferred that independent business enterprise 22 operate from business facility 23 which may be located within outer boundary 14. Business facility 23 may be any structure which functions to contain the business operations of independent business enterprise 22. Business facility 23 may be a building owned by privately owned correctional facility 11 and leased to independent business enterprise 22. More preferably, business facility 23 is a building which has been constructed by independent business enterprise 22 at its expense.

Preferably, independent business enterprise 22 employs prisoner workforce 24 which may constitute all or part of general prison population 12. Independent business enterprise 22 may pay salary 25 to prisoner workforce 24. Salary 25 may be an annual salary or an hourly salary. Preferably salary 25 is an hourly salary. The amount of salary 25 is preferably no less than minimum wage and more preferably, minimum wage.

In addition to salary 25, independent business enterprise 22 also prefarbly maintains responsibility for payment of workers' compensation expenses associated with prisoner workforce 24. Government entity 28 preferably maintains responsibility for all healthcare expenses associated with prisoner workforce 24.

By employing prisoner workforce 24, independent business enterprise 22 receives tax credit 31 from the state and/or federal government 32. Tax credit 31 may be a state and/or federal credit. Tax credit 31 provides independent business enterprise 22 advantages in the form of lower operating expenses that other competing businesses may not enjoy.

Privately owned correctional facility 11 preferably partners with independent business enterprise 22. Such partnering may include privately owned correctional facility 11 entering into a contract or understanding with independent business enterprise 22 pertaining to operations of a business from within outer boundary 14 and the employment of prisoner workforce 24. The contract or understanding with independent business enterprise 22 preferably is for a fixed term, as for example, a term of five or ten years.

As revealed in FIG. 2, prison system 10 further includes procedures whereby prisoner workforce 24 transfers portion 33 of salary 25 to privately owned correctional facility 11. Portion 33 transferred to correctional facility 11 is designed to compensate privately owned correctional facility 11 for services provided to prisoner workforce 24 (e.g., room and board). Preferably, portion 33 represents 30% to 50% of salary 25. More preferably, portion 33 represents 50% of salary 25. Portion 33 should not constitute more than $22.00 per prisoner per day.

Portion 34 of salary 25 (which is retained by prison workforce 24 and not paid to privately owned correctional facility 11) may be used by prisoner workforce 24 to pay for personal needs 35. Personal needs 35 may be any legitimate need, but preferably is in the nature of child support 36, court ordered restitution 37, court costs 38, court fines 39, hygiene needs 40, and/or canteen needs 41.

As shown in FIG. 2, prison system 10 may further include group of correctional facility employees 26. Preferably, group of correctional facility employees 26 is hired from community 27 which surrounds private correctional facility 11. It is preferred that the number of employees comprising group of correctional facility employees 26 be anywhere from 50 to 150 employees. More preferably, group of correctional facility employees 26 includes about 100 employees hired from community 27.

Group of correctional facility employees 26 may assist in the operation of private correctional facility 11. It is preferred that at least one employee from group of correctional facility employees 26 be responsible for providing banking services to prisoner workforce 24. More preferably, at least one employee from group of correctional facility employees 26 works in banking center 19. It is also preferred that at least one employee from group of correctional facility employees 26 be responsible for guarding prisoner workforce 24. For such duties, the employee may guard prisoner workforce 24 in business facility 23. It is to be understood that more than one employee from group of correctional facility employees 26 may be needed to work in banking center 19 and/or business facility 23.

Many benefits are obtained from prison system 10. For example, government entity 28 benefits because the overall cost of incarceration is reduced due to prisoner workforce 24 contributing to their own room and board by transfer of portion 33 to privately owned correctional facility 11. The privately owned correctional facility 11 operating expenses are lowered by the contribution (i.e., portion 33) made by prisoner workforce 24. Because of this, privately owned correctional facility 11 is able to offer government entity 28 reasonable or lesser charge 29 for housing prisoners 13, which in turn reduces taxpayer burden.

Prison system 10 of the present invention will have fewer internal problems within general prison population 12 as a result of the employment by independent business enterprise 22 of prisoner workforce 24. An engaged and active prisoner workforce 24 is less likely to cause disruption. With prisoner workforce 24 learning skills from their on the job training, the recidivism rates for prisoner workforce 24 may be reduced as prisoners 13 may find employment once they are released from prison and with the accumulation of salary resulting from their employment while incarcerated, prisoner workforce 13 is better able to adjust to life outside prison, as for example, they have funds to find a suitable place to live upon release and to support themselves until they find employment.

Independent business enterprise 22 reaps several benefits. Independent business enterprise 22 has a ready and willing pool of workers (i.e. prisoner workforce 24) able to work 24 hour shifts seven days a week. Independent business enterprise 22 pays prisoner workforce 24 no less than minimum wage. Independent business enterprise 22 does not pay any health insurance, overtime, maternity leave, or vacation pay for prisoner workforce 24. All health and medical services for prisoner workforce 24 will be provided for by privately owned correctional facility 11. Government entity 28 is responsible for paying all such healthcare expenses of prisoner workforce 24. Privately owned correctional facility 11 will also provide drug screening for prisoner workforce 24.

In addition, privately owned correctional facility 11 will also screen prisoner workforce 24 for work release. If any prisoner 13 comprising prisoner workforce 24 refuses to work, that prisoner 13 will be replaced and transferred to a more secure facility. If any prisoner 13 comprising prisoner workforce 24 fails an alcohol or drug screening, that prisoner 13 will suffer the loss of employment and will also be transferred from the facility.

A particular advantage of prison system 10 is derived from the introduction of banking center 19 into privately owned correctional facility 11 so that banking services may be provided to prisoner workforce 24. As mentioned previously, banking center 19 is operated by privately owned correctional facility 11. Banking center 19 preferably maintains an accounting department that deposits all or part of salary 25 paid to prisoner workforce 24. Banking center 19 may disperse portion 33 and/or portion 34 of salary 25. Portion 34 may be dispersed by banking center 19 at the request of prisoner 13 comprising prisoner workforce 24 in order to take care of personal needs 35. Banking center 19 will have oversight concerning the individual account of each prisoner 13 comprising prisoner workforce 24 and may print a weekly record of all activity in the account, which may made available to prisoner 13 for review.

Besides getting work experience, prisoner workforce 24 benefits from prison system 10 because they are able to retain portion 34 of salary 25. As mentioned previously, portion 34 can be used to meet personal needs 35, as for example to pay child support 36.

While preferred embodiments of the present invention have been described, it is to be understood that the embodiments described are illustrative only and that the scope of the invention is to be defined solely by the appended claims when accorded a full range of equivalence, many variations and modifications naturally occurring to those skilled in the art from a perusal hereof.

What is claimed is:

1. A prison system, comprising:
a privately owned correctional facility including a general prison population of prisoners, an outer boundary containing said general prison population, a detention unit for housing said general prison population, said detention unit being located within said outer boundary;
an independent business enterprise operating a business within said outer boundary, said independent business enterprise employing a prisoner workforce from said general prison population and paying said prisoner workforce a salary;
wherein said detention unit further includes a banking center, said banking center being operated by said privately owned correctional facility and providing banking services to said prisoner workforce.

2. The prison system of claim 1, further comprising a group of correctional facility employees hired from a community surrounding said private correctional facility, said group of correctional facility employees assisting in the operation of said private correctional facility.

3. The prison system of claim 2, wherein at least one employee from said group of correctional facility employees is responsible for providing banking services to said prisoner workforce.

4. The prison system of claim 2, wherein at least one employee from said group of correctional facility employees is responsible for guarding said prisoner workforce.

5. A prison system, comprising:
a privately owned correctional facility including a general prison population of prisoners, an outer boundary containing said general prison population, a detention unit for housing said general prison population, said detention unit being located within said outer boundary and comprising a circular-shaped central building, and a plurality of prisoner housing units extending outwardly from said circular-shaped central building;
an independent business enterprise operating a business from a business facility located within said outer boundary, said independent business enterprise employing a prisoner workforce from said general prison population and paying said prisoner workforce a salary; and
a group of correctional facility employees hired from a community surrounding said private correctional facility, said group of correctional facility employees assisting in the operation of said private correctional facility.

6. The prison system of claim 5, wherein said detention unit has two to four prisoner housing units.

7. The prison system of claim 6, wherein each of said prisoner housing units has a distal end and a proximal end, said distal end being rectangularly-shaped and containing between 50 and 80 dorms for locking down said prisoners, said proximal end being a pathway which interconnects said distal end to said circular-shaped central building.

8. The prison system of claim 5, wherein said circular-shaped central building includes an administrative office, a library, a cafeteria, and a banking center.

9. The prison system of claim 5, wherein at least one employee from said group of correctional facility employees works in said banking center and is responsible for providing banking services to said prisoner workforce.

10. The prison system of claim 5, wherein at least one employee from said group of correctional facility employees works in said business facility and is responsible for guarding said prisoner workforce.

11. The prison system of claim 5, wherein said banking center includes a means for providing banking services to said prisoner workforce.

12. A method of partnering an independent business enterprise with a privately owned correctional facility comprising the steps of:
a) establishing said privately owned correctional facility within a community, said privately owned correctional facility comprising a general prison population of prisoners supplied by a government entity, an outer boundary containing said general prison population, and a detention unit located within said outer boundary for housing said general prison population; said privately owned correctional facility charging a fee to said government entity for housing said general prison population and receiving said fee from said government entity; said privately owned correctional facility hiring a group of correctional facility employees from said community, said correctional facility employees assisting in the operation of said privately owned correctional facility;
b) partnering said independent business enterprise with said privately owned correctional facility, said independent business enterprise operating a business from a business facility located within said outer boundary of said privately owned correctional facility; said independent business enterprise employing a prisoner workforce from said general prison population and paying said workforce a salary;
wherein said privately owned correctional facility operates a banking center which provides banking services to said prisoner workforce.

13. The method of claim 12, wherein said independent business enterprise receives a tax credit for employing said prisoner workforce.

14. The method of claim 12, wherein said prisoner workforce transfers a portion of said salary to said privately owned correctional facility as compensation for services provided to said prisoner workforce by said private correctional facility.

15. The method of claim 14, wherein said portion is 30% to 50% of said salary.

16. The method of claim 15, wherein said prisoner workforce is capable of using a portion of said salary not transferred to said privately owned correctional facility to pay for a personal need selected from the group consisting of child support, court ordered restitution, court costs, court fines, personal hygiene needs, and canteen needs.

17. The method of claim 12, wherein said salary paid to said prisoner workforce is not less than minimum wage.

18. The method of claim 12, wherein said independent business enterprise is responsible for worker compensation expenses associated with said prisoner workforce.

19. The method of claim 12, wherein said privately owned correctional facility is responsible for healthcare expenses associated with said prisoner workforce.
